(19) United States
(12) Patent Application Publication
(10) Pub. No.: US 2011/0304746 A1
(43) Pub. Date: Dec. 15, 2011

(54) IMAGE CAPTURING DEVICE, OPERATOR MONITORING DEVICE, METHOD FOR MEASURING DISTANCE TO FACE, AND PROGRAM

(75) Inventors: Tomokuni Iijima, Kanagawa (JP); Satoshi Tamaki, Osaka (JP); Tomoyuki Tsurube, Tokyo (JP); Kenji Oka, Kanagawa (JP); Kensuke Maruya, Osaka (JP)

(73) Assignee: PANASONIC CORPORATION, Osaka (JP)

(21) Appl. No.: 13/201,340

(22) PCT Filed: Feb. 17, 2010
(86) PCT No.: PCT/JP2010/000980

§ 371 Date: Aug. 12, 2011

(30) Foreign Application Priority Data
Mar. 2, 2009 (JP) 2009-048499

(51) Int. Cl. H04N 5/235

(52) U.S. Cl. 348/229.1; 348/E05.037

(57) ABSTRACT

An imaging device (1) includes a camera unit (3) that captures images of the same object, respectively, using two optical systems, a face part detection unit (9) that detects a plurality of face parts composing a face included in each of the images captured by the camera unit (3), a face part luminance calculation unit (10) that calculates luminance of the detected plurality of face parts, and an exposure control value determination unit (12) that determines an exposure control value of the camera unit (3) based on the luminance of the plurality of face parts. A distance measurement unit (17) in the imaging device (1) measures distances to the face parts based on the images captured by the camera unit (3) using the exposure control value. Thus, the imaging device (1) can measure the distances to the face parts with high accuracy.

### TECHNICAL FIELD

The present invention relates to an imaging device having a function of measuring a distance to a face included in a captured image.

### BACKGROUND ART

Conventionally, a stereo camera has been used as an imaging device having a function of measuring a distance to an object (a distance measuring function). The stereo camera has a plurality of optical systems, and the optical systems differ in their optical axes. When the stereo camera captures an image of the same object, a parallax is generated between images respectively captured by the optical systems, and the parallax is found, to determine a distance to the object. For example, an image captured by one of the plurality of optical systems is a standard image, and images captured by the remaining optical systems are reference images. Similarities among the reference images are found, to determine a parallax by performing block matching using a part of the standard image as a template, and the distance to the object is calculated based on the parallax.

In order to correctly determine the parallax, a luminance of an image obtained by capturing the object must be appropriate. As an example of an inappropriate luminance, an exposure time is longer than an appropriate time so that saturation may occur. In this case, each object does not have an appropriate luminance corresponding to brightness, and the parallax cannot be correctly found. As a result, the distance to the object cannot correctly be measured. As another example of an inappropriate luminance, an exposure time may be shorter than an appropriate time so that a luminance may be low. In this case, a ratio of the luminance to random noise (a signal-to-noise (S/N) ratio) is low so that parallax accuracy is reduced. As a result, distance measurement accuracy is reduced.

Conventionally, an imaging device for making a luminance of a face appropriate has been discussed (see, for example, Patent Document 1). The conventional imaging device sets a plurality of cutout areas (e.g., three face detection area frames) from a captured image, and detects whether each of the cutout areas includes the face. Automatic exposure is performed so that a luminance of the cutout area including the face becomes appropriate. If an area where a face is detected is only one face detection area frame, for example, a diaphragm and a shutter speed are determined so that a luminance in the face detection area frame becomes appropriate. If faces are respectively detected in the two face detection area frames, a diaphragm and a shutter speed are determined so that respective average luminance in the face detection area frames become appropriate. Further, if faces are respectively detected in all three face detection area frames, a diaphragm and a shutter speed are determined so that respective average luminance in all the face detection area frames become appropriate. If a face is not detected in any of the face detection area frames, a diaphragm and a shutter speed are determined so that average luminance in the three face detection area frames become appropriate.

In the conventional imaging device, however, the cutout area is previously set. If the cutout area includes a high-luminance object (e.g., a light) in addition to an original object (face), control is performed so that an exposure time is shortened by an amount corresponding to the high-luminance object. As a result, a luminance of the face is reduced, and the S/N ratio is reduced. Therefore, parallax accuracy is reduced, and distance measurement accuracy is reduced.

### PRIOR ART DOCUMENT LIST

### Patent Document

### Patent Document 1

Japanese Patent Laid-Open No. 2007-81732

### SUMMARY OF INVENTION

### Technical Problem

The present invention has been made under the above-mentioned background. The present invention is directed to an imaging device capable of performing exposure control so that a luminance of a face is made appropriate and capable of accurately measuring a distance to the face.

### Solution to Problem

According to an aspect of the present invention, an imaging device includes a camera unit that captures at least two images of the same object, respectively, using at least two optical systems, a face part detection unit that detects, from each of the at least two images captured by the camera unit, a plurality of face parts composing a face included in the image, a face part luminance calculation unit that calculates luminance of the detected plurality of face parts, an exposure control value determination unit that determines an exposure control value of the camera unit based on the luminance of the plurality of face parts, and a distance measurement unit that measures distances to the plurality of face parts based on the at least two images captured by the camera unit using the corrected exposure control value.

According to an aspect of the present invention, a driver monitoring device includes a camera unit that captures at least two images of a driver as an object of shooting, respectively, using at least two optical systems, a face part detection unit that detects a plurality of face parts composing a face of the driver from each of the at least two images captured by the camera unit, a face part luminance calculation unit that calculates luminance of the detected plurality of face parts, an exposure control value determination unit that determines an exposure control value of the camera unit based on the luminance of the plurality of face parts, a distance measurement unit that measures distances to the plurality of face parts of the driver based on the at least two images captured by the camera unit using the exposure control value, a face model generation unit that generates a face model of the driver based on distance measurement results of the plurality of face parts, and face tracking processing unit that performs processing for tracking a direction of the face of the driver based on the generated face model.

According to another aspect of the present invention, a method for measuring a distance to a face includes capturing at least two images of the same object, respectively, using at least two optical systems, detecting a plurality of face parts composing the face included in each of the at least two captured images, calculating luminance of the detected plurality of face parts, determining an exposure control value for image capturing based on the luminance of the plurality of face parts, and measuring distances to the faces based on the at least two images captured using the exposure control value.

According to a further aspect of the present invention, a program for measuring a distance to a face causes a computer to execute processing for detecting a plurality of face parts composing the face included in each of at least two images of the same object, which have been respectively captured by at least two optical systems, processing for calculating luminance of the detected plurality of face parts, processing for determining an exposure control value for image capturing based on the luminance of the plurality of face parts, and processing for measuring distances to the faces based on the at least two images captured using the exposure control value.

The present invention includes another aspect, as described below. Therefore, the disclosure of the present invention intends to provide an aspect of a part of the present invention, and does not intend to limit the scope of the invention described and claimed herein.

### BRIEF DESCRIPTION OF DRAWINGS

FIG. 1 is a block diagram illustrating a configuration of an imaging device according to a first embodiment.

FIG. 2 illustrates processing in a face part detection unit (face part detection processing).

FIG. 3 is a block diagram illustrating a configuration of an exposure control value determination unit.

FIG. 4 illustrates processing in a face detection unit (face detection processing).

FIG. 5 is a block diagram illustrating a configuration of an exposure control value correction unit.

FIG. 6 illustrates block matching processing in a distance measurement unit.

FIG. 7 is a flowchart for illustrating an operation of the imaging device according to the first embodiment.

FIG. 8 is a flowchart for illustrating an operation of exposure control.

FIG. 9 illustrates an example of an average luminance of the whole face and luminance of face parts when a lighting condition is changed in the first embodiment.

FIG. 10 illustrates a modified example (compared with the first embodiment) when luminance of face parts are selected.

FIG. 11 is a schematic view illustrating an example of a driver monitoring device according to a second embodiment.

FIG. 12 is a front view of the driver monitoring device.

FIG. 13 is a block diagram illustrating a configuration of the driver monitoring device.

FIG. 14 is a flowchart for illustrating an operation of the driver monitoring device according to the second embodiment.

### DESCRIPTION OF EMBODIMENTS

Detailed description of the present invention will be described below. The following detailed description and the appended figures do not limit the present invention. Alternatively, the scope of the invention is defined by the scope of the appended claims.

An imaging device according to the present invention includes a camera unit that captures at least two images of the same object, respectively, using at least two optical systems, a face part detection unit that detects, from each of the at least two images captured by the camera unit, a plurality of face parts composing a face included in the image, a face part luminance calculation unit that calculates luminance of the detected plurality of face parts, an exposure control value determination unit that determines an exposure control value of the camera unit based on the luminance of the plurality of face parts, an exposure control value correction unit that corrects the exposure control value of the camera unit based on the luminance of the face parts, and a distance measurement unit that measures distances to the plurality of face parts based on the at least two images captured by the camera unit using the corrected exposure control value. By this configuration, the exposure control value (a diaphragm value, an exposure time, a gain, etc.) is appropriately found based on the luminance of the face parts (an inner corner of the eye, a tail of the eye, a lip edge, etc.). In this manner, exposure control is performed so that the luminance of the face parts become appropriate. Therefore, a parallax between the face parts can be found with high accuracy, and the distances to the face parts can be measured with high accuracy.

In the imaging device according to the present invention, the exposure control value determination unit may determine the exposure control value of the camera unit so that the maximum one of the luminance of the plurality of face parts becomes a predetermined target luminance. By this configuration, the maximum one of the luminance of the plurality of face parts is used as a target value. Therefore, appropriate exposure control can be more easily performed for a change in a lighting condition than that when an average luminance is used as a target value. Even when the lighting condition is changed (e.g., when the lighting condition is changed from “lighting from the front” of the object to “lighting from the side” thereof), therefore, exposure control is easily performed so that the luminance of the face part becomes appropriate.

In the imaging device according to the present invention, the exposure control value determination unit may determine, when a difference between the luminance of a pair of face parts symmetrically arranged out of the plurality of face parts is greater than a predetermined threshold value, the exposure control value of the camera unit so that the maximum one of the luminance of the face parts excluding the pair of face parts becomes a target luminance. By this configuration, if the difference between the luminance of the pair of face parts symmetrically arranged (e.g., a left tail of the eye and a right tail of the eye) is great, the luminance of the face parts are not used as target values. More specifically, the excessively large and excessively small luminance of the face parts are excluded from the target values. Thus, the luminance of the face parts within a range of appropriate luminance (luminance that slightly differ) are used as the target values to perform exposure control so that appropriate exposure control can be performed.

The imaging device according to the present invention may further include a face detection unit that detects the face included in each of the at least two images captured by the camera unit, a face luminance calculation unit that calculates luminance of the detected faces, and an exposure control value correction unit that corrects the exposure control value of the camera unit based on the luminance of the faces, in which the exposure control value correction unit may correct the exposure control value of the camera unit so that the luminance of the face parts included in the at least two images captured by the camera unit are the same. By this configuration, the exposure control value (a diaphragm value, an exposure time, a gain, etc.) is corrected so that a difference between the luminance of the faces used to calculate a parallax becomes small. Therefore, the parallax between the face parts can be found with high accuracy, and distances to the face parts can be measured with high accuracy.

In the imaging device according to the present invention, the exposure control value may include a diaphragm value, an exposure time, and a gain, and the exposure control value correction unit may make the respective diaphragm values and exposure times of the two optical systems the same, and correct the respective gains of the two optical systems so that the luminance of the face parts included in the two images become the same. By this configuration, there can be no difference in luminance between the two optical systems used for parallax calculation. Therefore, parallax calculation accuracy becomes high, and distance calculation accuracy can be increased.

In the imaging device according to the present invention, the exposure control value determination unit may set a target luminance depending on the selected one of the luminance of the plurality of face parts, and may determine the exposure control value of the camera unit so that the selected luminance becomes the target luminance. By this configuration, the target value is appropriately set according to the luminance of the face parts.

In the imaging device according to the present invention, the exposure control value determination unit may set the target luminance to a smaller value when the selected luminance is larger than a predetermined threshold value than that when the selected luminance is smaller than the threshold value. By this configuration, exposure control is performed so that the luminance quickly becomes an appropriate luminance in a short time by making the target value smaller when high. Therefore, a period of time during which distance measurement accuracy is low because the luminance is too high can be shortened.

The imaging device according to the present invention, the exposure control value determination unit may control a frequency at which the exposure control value of the camera unit is found based on the presence or absence of a saturation signal indicating that the luminance of the face part is higher than a predetermined reference saturation value. By this configuration, the exposure control value is determined at appropriate timing based on the presence or absence of the saturation signal.

In the imaging device according to the present invention, the exposure control value determination unit may determine the exposure control value of the camera unit every time the image is captured when the saturation signal is present. By this configuration, exposure control is performed so that an appropriate luminance is quickly obtained in a short time by calculating the exposure control value immediately when saturation of the luminance occurs. Therefore, a period of time during which distance measurement accuracy is low because the luminance is too high can be shortened.

A driver monitoring device according to the present invention includes a camera unit that captures at least two images of a driver as an object of shooting, respectively, using at least two optical systems, a face part detection unit that detects a plurality of face parts composing a face of the driver from each of the at least two images captured by the camera unit, a face part luminance calculation unit that calculates luminance of the detected plurality of face parts, an exposure control value determination unit that determines an exposure control value of the camera unit based on the luminance of the plurality of face parts, a distance measurement unit that measures distances to the plurality of face parts of the driver based on the at least two images captured by the camera unit using the exposure control value, a face model generation unit that generates a face model of the driver based on distance measurement results of the plurality of face parts, and a face tracking processing unit that performs processing for tracking a direction of the face of the driver based on the generated face model. By this configuration, the exposure control value (a diaphragm value, an exposure time, a gain, etc.) is appropriately found based on the luminance of the face parts (an inner corner of the eye, a tail of the eye, a lip edge, etc.). In this manner, exposure control is performed so that the luminance of the face parts become appropriate. Therefore, a parallax between the face parts can be found with high accuracy, and the distances to the face parts can be measured with high accuracy. The direction of the face is tracked using accurate distances to the face parts. Therefore, the direction of the face can be tracked with high accuracy.

A method for measuring a distance to a face according to the present invention includes capturing at least two images of the same object, respectively, using at least two optical systems, detecting a plurality of face parts composing the face included in the at least two captured images, calculating luminance of the detected plurality of face parts, determining an exposure control value for image capturing based on the luminance of the plurality of face parts, correcting the exposure control value for image capturing based on the luminance of the plurality of face parts, and measuring distances to the faces based on the at least two images captured using the corrected exposure control value. By this method, exposure control is also performed so that the luminance of the face parts become appropriate, like that in the above-mentioned imaging device. Therefore, a parallax between the face parts can be found with high accuracy, and the distances to the face parts can be measured with high accuracy.

A program for measuring a distance to a face according to the present invention causes a computer to execute processing for detecting a plurality of face parts composing the face included in each of at least two images of the same object, which have been respectively captured by at least two optical systems, processing for calculating luminance of the detected plurality of face parts, processing for determining an exposure control value for image capturing based on the luminance of the plurality of face parts, and processing for measuring distances to the faces based on the at least two images captured using the exposure control value. By this program, exposure control is also performed so that the luminance of the face parts become appropriate, like that in the above-mentioned imaging device. Therefore, a parallax between the face parts can be found with high accuracy, and the distances to the face parts can be measured with high accuracy.

The present invention is directed to providing an exposure control value determination unit for determining an exposure control value based on luminance of face parts so that distances to the face parts can be measured with high accuracy.

Imaging devices according to embodiments of the present invention will be described below with reference to the figures.

### First Embodiment

In a first embodiment of the present invention, an imaging device used for a camera-equipped mobile phone, a digital still camera, an in-vehicle camera, a monitoring camera, a three-dimensional measuring machine, a three-dimensional image input camera, or the like will be illustrated by an example. While the imaging device has a face distance measuring function, the function is implemented by a program stored in a hard disk drive (HDD), a memory, or the like contained in the device.

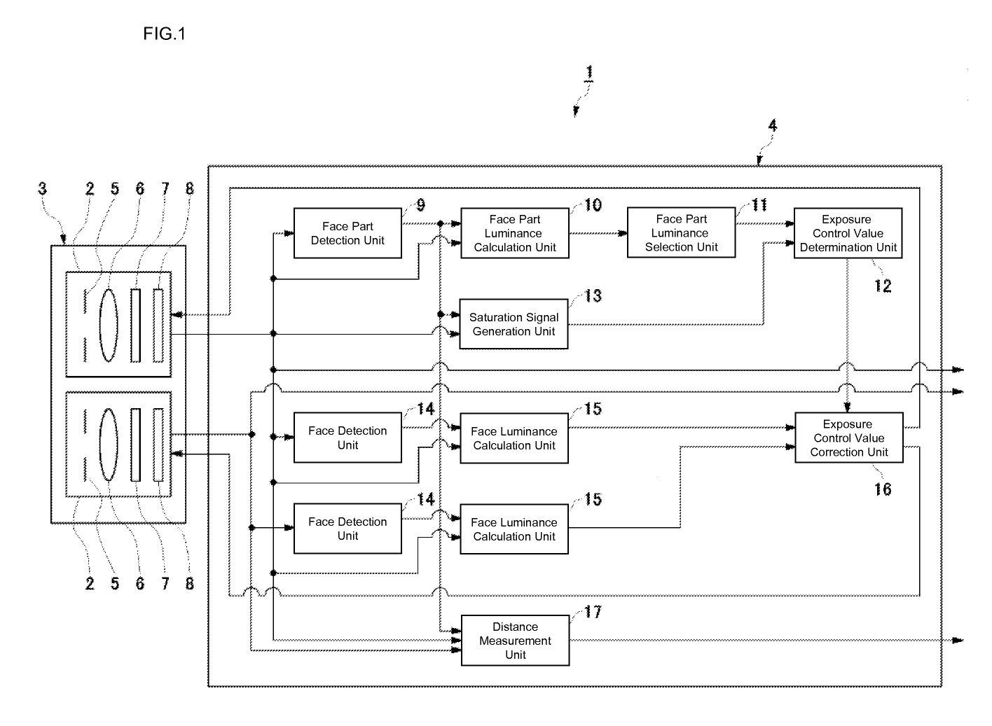

A configuration of the imaging device according to the present embodiment will be first described with reference to FIGS. 1 to 6. FIG. 1 is a block diagram illustrating the configuration of the imaging device according to the present embodiment. As illustrated in FIG. 1, an imaging device 1 includes a camera unit 3 including two optical systems 2 (first and second optical systems 2), and a control unit 4 composed of a central processing unit (CPU), a microcomputer, or the like.

A configuration of each of the two optical systems 2 will be first described. The first optical system 2 (the upper optical system 2 in FIG. 1) includes a first diaphragm 5, a first lens 6, a first image sensor 7, and a first circuit unit 8. The second optical system 2 (the lower optical system 2 in FIG. 1) includes a second diaphragm 5, a second lens 6, a second image sensor 7, and a second circuit unit 8. The two optical systems 2 can respectively capture images of the same object.

When the camera unit 3 captures the same object, in the first optical system 2, light incident on the first lens 6, which has passed through the first diaphragm 5, is focused onto an imaging plane of the first image sensor 7, and an electrical signal from the image sensor 7 is subjected to processing such as noise removal, gain control, and analog/digital conversion by the first circuit unit 8, and is output as a first image. In the second optical system 2, light incident on the second lens 6, which has passed through the second diaphragm 5, is focused onto an imaging plane of the second image sensor 7, and an electrical signal from the image sensor 7 is subjected to processing such as noise removal, gain control, and analog/digital conversion by the second circuit unit 8, and is output as a second image.

The first image and the second image are input to the control unit 4. In the control unit 4, various types of processing are performed, as described below, so that a first exposure control value and a second exposure control value are output. The first exposure control value and the second exposure control value are input to the camera unit 3, and are used for exposure control in the camera unit 3. The first image and the second image are also output to the exterior.

The first exposure control value includes a first diaphragm value, a first exposure time, and a first gain. In the first optical system 2, exposure control is performed based on the first exposure control value. More specifically, in the first optical system 2, an opening of the first diaphragm 5 is controlled based on the first diaphragm value, an electronic shutter in the first image sensor 7 is controlled based on the first exposure time, and a gain of the first circuit unit 8 is controlled based on the first gain.

The second exposure control value includes a second diaphragm value, a second exposure time, and a second gain. In the second optical system 2, exposure control is performed based on the second exposure control value. More specifically, in the second optical system 2, an opening of the second diaphragm 5 is controlled based on the second diaphragm value, an electronic shutter in the second image sensor 7 is controlled based on the second exposure time, and a gain of the second circuit unit 8 is controlled based on the second gain.

In this case, the first and second optical systems 2 are spaced apart in a horizontal direction of an image. Therefore, a parallax is generated in the horizontal direction of the image. The first image and the second image are subjected to various types of correction (calibration). For example, the first image and the second image are subjected to shading correction, are corrected so that their optical axis centers become the same positions in the images (e.g., image centers), are corrected so that there is no distortion around the optical axis centers, are subjected to magnification correction, and are corrected so that a direction in which a parallax is generated becomes the horizontal direction of the image.

Configurations of the control unit 4 will be described below. As illustrated in FIG. 1, the control unit 4 includes a face part detection unit 9 for detecting a plurality of face parts (an inner corner of the eye, a tail of the eye, a lip edge, etc.) from an image captured by the camera unit 3, a face part luminance calculation unit 10 for calculating a luminance of each of the face parts, a face part luminance selection unit 11 for selecting the maximum one of the luminance of the plurality of face parts, an exposure control value determination unit 12 for determining an exposure control value based on the luminance of the face part, and a saturation signal generation unit 13 for generating a saturation signal when the luminance of the face part is higher than a predetermined reference saturation value.

The control unit 4 includes a first face detection unit 14 for detecting a face from the image captured by the first optical system 2, a first face luminance calculation unit 15 for calculating a luminance of the face, a second face detection unit 14 for detecting a face from the image captured by the second optical system 2, a second face luminance calculation unit 15 for calculating a luminance of the face, an exposure control value correction unit 16 for correcting an exposure control value based on the luminance of the faces (and consequently, a first exposure control value and a second exposure control value are generated, as described below), and a distance measurement unit 17 for measuring a distance to the face based on the image captured by the camera unit 3 using the corrected exposure control value. The distance measurement unit 17 also has a function of measuring distances to face parts composing the face. The measured distance to the face (or the distance to the face part) is output to the exterior.

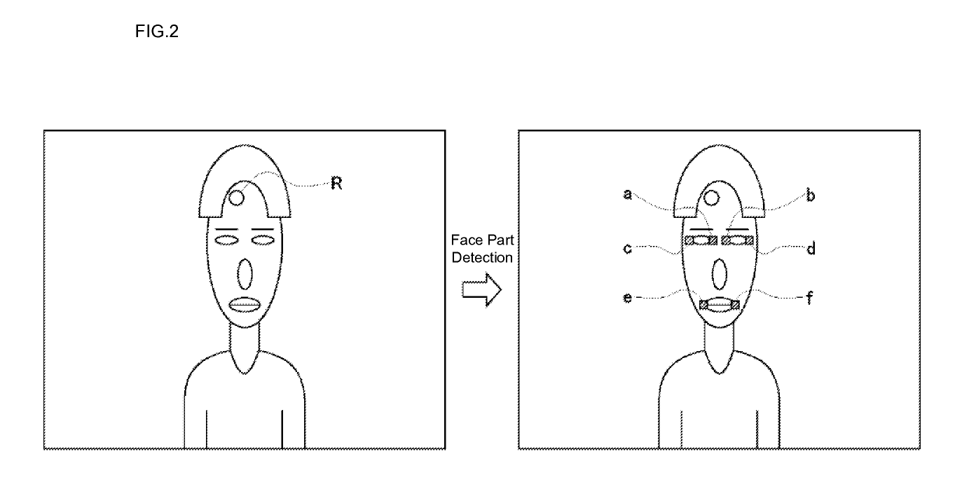

One, characteristic of the present invention, of the configurations of the control unit 4 will be described in detail with reference to the figures. FIG. 2 illustrates an example of processing in the face part detection unit 9 (face part detection processing). FIG. 2 illustrates an example in which six face parts (areas indicated by hatching in FIG. 2) are detected from an image of a person captured by the camera unit 3 (first optical system 2). In this example, a square area in the vicinity of a “right inner corner of the eye”, a square area in the vicinity of a “left inner corner of the eye”, a square area in the vicinity of a “right tail of the eye”, a square area in the vicinity of a “left tail of the eye”, a square area in the vicinity of a “right lip edge”, and a square area in the vicinity of a “left lip edge” are respectively detected as a first face part a, a second face part b, a third face part c, a fourth face part d, a fifth face part e, and a sixth face part f. In this case, even if light from a light is reflected on a forehead wet with sweat or the like so that a high-luminance area R exists, such an area (an area in the vicinity of the forehead) is not detected as a face part. The face part detection unit 9 outputs positions of the face parts a to f (also referred to as face part positions) to the face part luminance calculation unit 10, the saturation signal generation unit 13, and the distance measurement unit 17.

While the number of face parts is six as an example in FIG. 2, it is not limited to this. While the square area is the face part, the shape of the face part is not limited to this. For example, the shape of the face part may be other shapes such as rectangular, triangular, and trapezoidal shapes, and such a shape that the face part is surrounded by a curve.

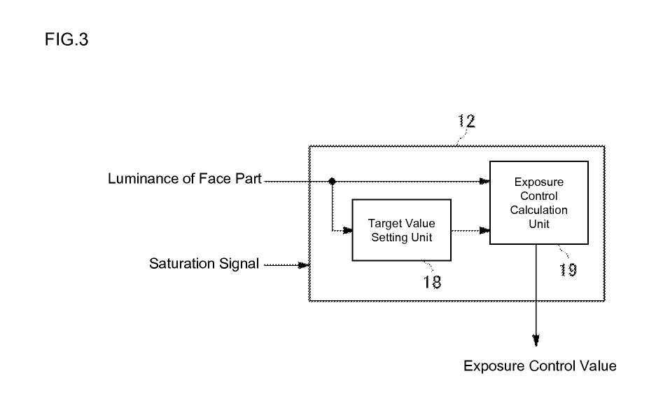

FIG. 3 is a block diagram illustrating a configuration of the exposure control value determination unit 12. As illustrated in FIG. 3, the exposure control value determination unit 12 includes a target value setting unit 18 and an exposure control calculation unit 19. The target value setting unit 18 has a function of setting a target luminance based on the luminance selected by the face part luminance selection unit 11. The exposure control calculation unit 19 has a function of determining an exposure control value so that the luminance selected by the face part luminance selection unit 11 becomes the target luminance. A detailed operation of the exposure control value determination unit 12 will be described below with reference to the figures.

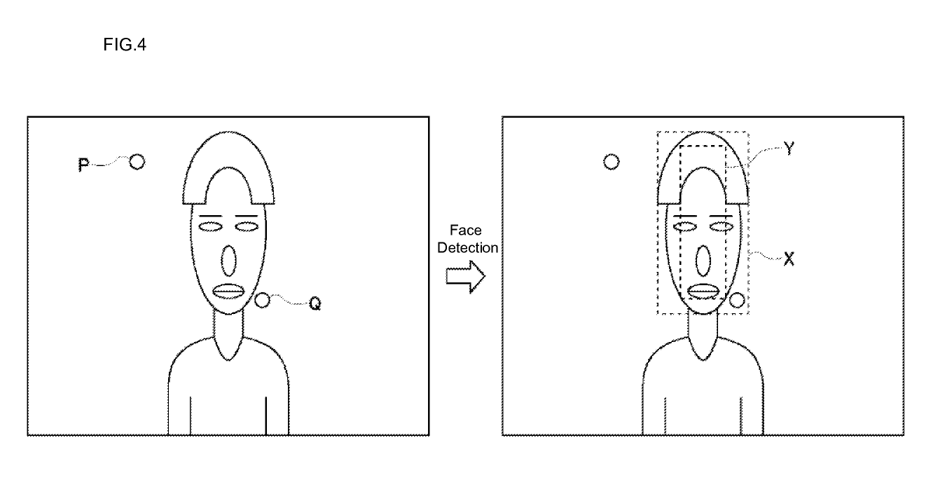

FIG. 4 illustrates an example of processing in the face detection unit 14 (face detection processing). FIG. 4 illustrates an example in which a face is detected from an image of a person captured by the camera unit 3 (the first optical system 2 and the second optical system 2). For example, an area X in the shape of a large rectangle including the whole face of the person (e.g., a rectangle circumscribing the face) is detected as a face. In this case, even if a high-luminance area P such as a light exists in a portion spaced apart from the face of the person, the area X not including the high-luminance area P can be detected as a face. An area Y in the shape of a small rectangle including a part of the face of the person (e.g., a rectangle inscribing the face) may be detected as a face. In this case, even if a high-luminance area Q such as a light exists in the vicinity of the face of the person, the area Y not including the high-luminance area Q can be detected as a face. The contour of the face of the person may be detected, and an area surrounded by the contour of the face may be detected as a face.

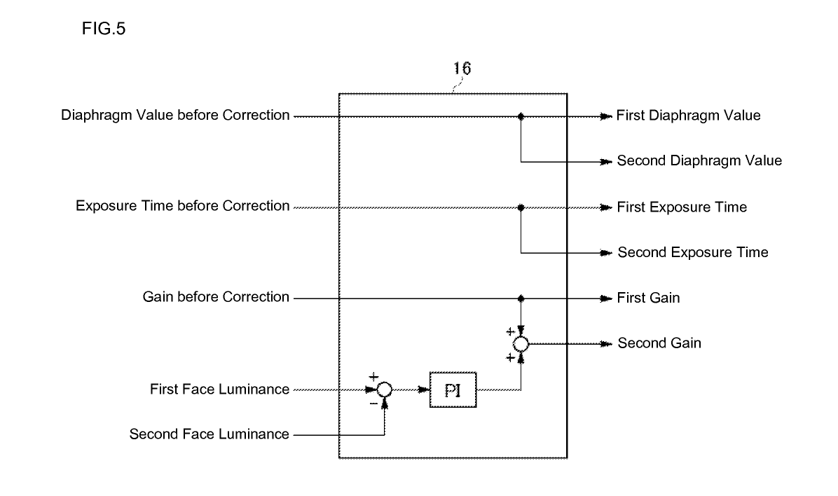

FIG. 5 is a block diagram illustrating a configuration of the exposure control value correction unit 16. As illustrated in FIG. 5, the exposure control value correction unit 16 outputs a diaphragm value before correction (the same diaphragm value) as a “first diaphragm value” and a “second diaphragm value”. The exposure control value correction unit 16 outputs an exposure time before correction (the same exposure time) as a “first exposure time” and a “second exposure time”. The exposure control value correction unit 16 outputs a gain before correction as a “first gain”, and subtracts a second face luminance from a first face luminance, determines a result obtained by proportional-plus-integral control of a subtraction result as an offset, and outputs a result obtained by adding the offset to the gain before correction as a “second gain”.

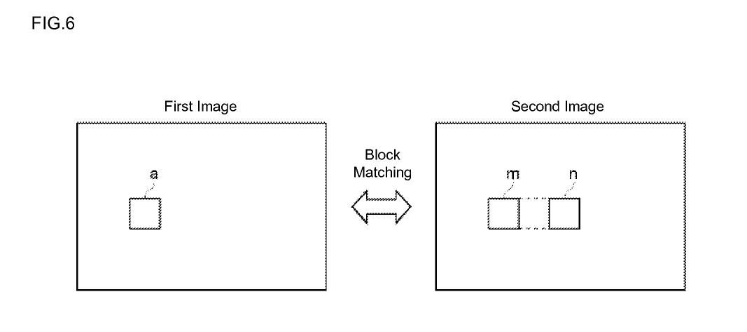

FIG. 6 illustrates an example of block matching processing in the distance measurement unit 17. As illustrated in FIG. 6, the distance measurement unit 17 performs block matching while shifting an area indicated by a face part (e.g., a first face part a) on the first image one pixel at a time from a corresponding position (e.g., a position m corresponding to the first face part a) on the second image to a predetermined position n in a horizontal direction (a direction in which a parallax is generated) as a template. A shift amount having the highest similarly is taken as a first parallax Δ1. Further, a first distance L1 is found using the following equation 1 based on the principle of triangulation. The first parallax Δ1 is substituted into Δ in the equation 1, and a result L obtained by calculation using the equation 1 is a first distance L1:

L=(f×B)/(p×Δ) (Equation 1)

In the equation 1, L is a distance to the object, f is a focal length of the first lens 6, B is a distance between optical axes of the first and second optical systems 2, p is a distance in the horizontal direction between pixels composing the image sensor 7, and Δ is a parallax. A unit of the parallax Δ is a distance in the horizontal direction between the pixels composing the image sensor 7.

In a similar manner, block matching is also performed for the second face part b, the third face part c, the fourth face part d, the fifth face part e, and the sixth face part f, to respectively determine a second parallax Δ2, a third parallax Δ3, a fourth parallax Δ4, a fifth parallax Δ5, and a sixth parallax Δ6, and to respectively determine a second distance L2, a third distance L3, a fourth distance L4, a fifth distance L5, and a sixth distance L6 using the equation 1.

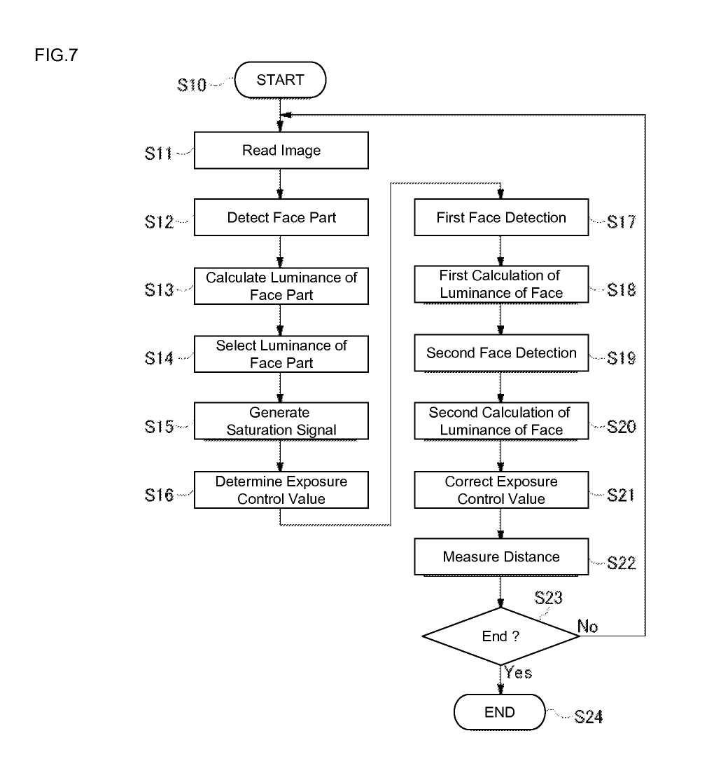

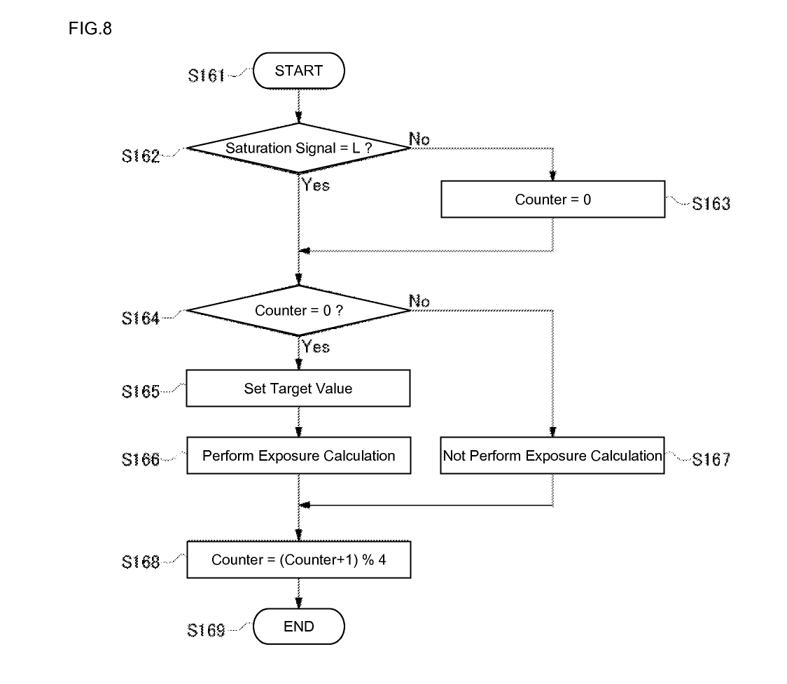

Operations of the imaging device 1 according to the first embodiment configured as described above will be described with reference to FIGS. 7 and 8.

FIG. 7 is a flowchart illustrating the flow of an operation of the control unit 4 when distance measurement is made using the imaging device 1. The operation of the imaging device 1 is started by a host device (e.g., a driver monitoring device using the imaging device 1), an instruction from a user, or the like (S10).

The control unit 4 first reads an image captured by the camera unit 3 (S11). In this case, the first image is read from the first optical system 2, and the second image is read from the second optical system 2. The read images are temporarily stored in a random read memory (RAM) or the like, as needed.

The first image is then input to the face part detection unit 9, and face parts are detected (S12). Positions of the detected face parts are output from the face part detection unit 9. Positions of the six face parts a to f are output, as illustrated in FIG. 2, for example. The first image and the respective positions of the face parts are input to the face part luminance calculation unit 10, and respective average luminance of the face parts are calculated (S13). Respective luminance of the face parts (e.g., respective average luminance of the face parts a to f) are output from the face part luminance calculation unit 10.

When the luminance of the face parts (the luminance of the face parts a to f) are input to the face part luminance selection unit 11, the maximum one of the luminance is selected (S14). If a difference between the luminance of the bilaterally symmetric face parts (e.g., a right lip edge and a left lip edge: the face parts e and f) is great, the face part luminance selection unit 11 may select the maximum one of the luminance of the other face parts excluding the bilaterally symmetric face parts (e.g., the face parts a to d). The luminance selected by the face part luminance selection unit 11 is output to the exposure control value determination unit 12.

The first image and the positions of the face parts are input to the saturation signal generation unit 13, and a saturation signal indicating whether saturation occurs or not is generated (S15). If saturation occurs in any of the six face parts a to f, for example, a saturation signal H indicating that occurrence of saturation is “present” is generated. If saturation does not occur in any of the face parts a to f, a saturation signal L indicating that occurrence of saturation is “absent” is generated. The saturation signal generated by the saturation signal generation unit 13 is output to the exposure control value determination unit 12.

The selected luminance and the saturation signal are input to the exposure control value determination unit 12, and an exposure control value of the camera unit 3 (an exposure control value before correction: a diaphragm value before correction, an exposure time before correction, a gain before correction) is found (S16).

An operation of the exposure control value determination unit 12 will be described in detail with reference to FIG. 8. FIG. 8 is a flowchart illustrating the flow of processing in the exposure control value determination unit 12. As illustrated in FIG. 8, when the operation of the exposure control value determination unit 12 is started (S161), it is determined whether the saturation signal is “L” or not (occurrence of saturation is “absent”) (S162).

If the saturation signal is “H” (occurrence of saturation is “present”), a value of a counter N is initialized to “0” (S163). On the other hand, if the saturation signal is “L” (occurrence of saturation is “absent”), the counter N is not initialized.

It is then determined whether the value of the counter N is “0” or not (S164). If the value of the counter N is “0”, exposure calculation processing is performed. More specifically, the target value setting unit 18 sets a target luminance based on the selected luminance (S165). For example, if the selected luminance is less than a predetermined threshold value, the target luminance is set to a first target value (a predetermined target value). On the other hand, if the selected luminance is the threshold value or more, the target luminance is set to a second target value (a target value smaller than the first target value).

In the exposure control calculation unit 19, an exposure control value (an exposure control value before correction) is determined based on the selected luminance and the target luminance. For example, an exposure control value (a diaphragm value before correction, an exposure time before correction, a gain before correction) is determined so that the selected luminance becomes the target luminance, and is output from the exposure control value determination unit 12. On the other hand, if the value of the counter is not “0” in step S164, the above-mentioned exposure calculation processing (steps S165 and S166) is not performed. In this case, the same exposure control value as an exposure control value output last time is output from the exposure control value determination unit 12.

A remainder left when “1” is added to the counter N and an addition result is divided by “4” is set to a new counter N (S168). The exposure control value determination unit 12 ends the operation (S169).

A case where the remainder left when “1” is added to the counter N and an addition result is divided by “4” is found in step S168, it is determined whether the counter N is “0” in step S164, and the exposure calculation processing (steps S165 and S166) is executed only when the counter N is “0” has been illustrated by an example. More specifically, a case where exposure calculation processing (target value setting and exposure control calculation) is performed only once per four times of image reading.

The scope of the present invention is not limited to this. For example, the addition result may be divided by a divisor “3” in step S168, or the divisor may be changed, as needed. Thus, exposure calculation is performed only once per several times (e.g., four times) so that a calculation time in the whole imaging device 1 can be made shorter than that when exposure calculation is performed each time. The larger the divisor is, the shorter the calculation time in the whole imaging device 1 becomes. If a certain degree of waiting time is required from setting of an exposure control value (an exposure time, etc.) until an image on which the exposure control value (the exposure time, etc.) is reflected is accepted, the divisor is changed so that the waiting time can be adjusted, as needed.

In this case, if the saturation signal 39 is “H” (occurrence of saturation is “present”) in step S162, the counter N is initialized to zero in step S163, it is determined that the counter N is zero in step S164, and the exposure calculation processing (steps S165 and S166) is executed. When the saturation signal is “H” (occurrence of saturation is “present”), therefore, the setting of the target value (step S165) and the exposure control calculation (step S166) are always executed. If the brightness of the object is not changed, a state of the saturation signal is not changed (the saturation signal remains “H”) until an image on which the exposure control value (the exposure time, etc.) is reflected is accepted. Therefore, the processing in step S162 may be omitted. While a case where the exposure control calculation is always performed when occurrence of saturation is “present” is illustrated by an example, the scope of the present invention is not limited to this. For example, when occurrence of saturation is “present”, the exposure control calculation may be stopped only three times after the counter N is initialized to zero.

Referring to FIG. 7 again, description of the operation of the control unit 4 will be continued. The first image is input to the first face detection unit 14, and a first face is detected from the image (S17). A position of the first face is output from the first face detection unit 14. For example, a position of the area Y of the face is output, as illustrated in FIG. 4. The first image and the position of the first face are input to the first face luminance calculation unit 15, and an average luminance of the first face (e.g., the area Y) is calculated (S18). A luminance of the first face (the average luminance of the area Y) is output from the first face luminance calculation unit 15.

Similarly, the second image is input to the second face detection unit 14, and a second face is detected from the image (S19). A position of the second face is output from the second face detection unit 14. The second image and the position of the second face are input to the second face luminance calculation unit 15, and an average luminance of the second face is calculated (S20). A luminance of the second face is output from the second face luminance calculation unit 15.

The exposure control value (an exposure control value before correction) found by the exposure control value determination unit 12, the luminance of the first face, and the luminance of the second face are input to the exposure control value correction unit 16, the exposure control value is corrected, and an exposure control value (a first exposure control value and a second exposure control value) after correction is output (S21). For example, the same exposure control value (a diaphragm value, an exposure time, a gain) as that before correction is output as the first exposure control value, and the same diaphragm value as that before correction, the same exposure time as that before correction, and a gain obtained by adding an offset to the gain before correction are output as the second exposure control value.

The image (the first image and the second image) captured using the exposure control value after correction and the positions of the face parts (e.g., positions of the six face parts a to f) detected from the image are input to the distance measurement unit 17, and distances to the face parts are measured (S22). The distances to the face parts (e.g., the six face parts a to f) are output from the distance measurement unit 17.

The control unit 4 finally determines whether the operation ends or not (S23). When it is determined that the operation ends, the control unit 4 ends the operation (S24).

The imaging device 1 according to the first embodiment produces the following function and effect. More specifically, in the imaging device 1 according to the present embodiment, face parts are detected from an image, respective average luminance of the face parts are found, and exposure control is performed based on the maximum one of the average luminance. Thus, luminance of the face parts are made appropriate. Therefore, an accurate parallax between the face parts can be found, and thus accurate distances to the face parts can be found.

In the imaging device 1 according to the present embodiment, faces are respectively detected from images captured by the two optical systems 2, respective average luminance of the faces for the two optical systems are found, and gains of the optical systems are respectively controlled so that both the average luminance become the same. Thus, luminance of the two optical systems 2 in the faces are made the same. Therefore, the faces can be accurately block-matched, an accurate parallax between the faces can be found, and thus distances to the faces can be accurately measured.

More specifically, in the imaging device 1 according to the first embodiment, the face part detection unit 9 recognizes a face part position serving as information relating to a face position, the face part luminance calculation unit 10 calculates a luminance of the face part based on the face part position, the exposure control value determination unit 12 performs exposure control using a selected luminance of the face part generated based on the luminance of the face part, and the distance measurement unit 17 generates a distance to the face part position that is a part of the face based on the first image and the second image.

Thus, the luminance of the face can be appropriately controlled even if there is a high-luminance portion (e.g., the high-luminance area P illustrated in FIG. 4) other than the face position in the image. On the other hand, in a conventional imaging device, an area is previously divided into areas, and the area including a face is detected. If a high-luminance area is included in the vicinity of the face, therefore, exposure control is performed based on information relating to a luminance of an area including the high-luminance area. Therefore, the luminance of the face becomes excessively low (a signal-to-noise (S/N) ratio becomes low). Therefore, parallax accuracy is low, and distance measurement accuracy is reduced. On the other hand, in the present embodiment, the luminance of the face does not become excessively high (saturation does not occur), and does not become excessively low (because an S/N ratio is high). Therefore, parallax accuracy is increased, and distance measurement accuracy is improved.

Moreover, in the present embodiment, even if there is not only one high-luminance portion but also a plurality of high-luminance portions (e.g., the high-luminance areas P and Q illustrated in FIG. 4) other than the face position, exposure control is performed based on a luminance of the face position so that the luminance of the face position can be appropriately controlled. Further, even if luminance of the plurality of high-luminance portions differ from one another, and if the high-luminance portions are in the vicinity of the face, exposure control is performed based on the luminance of the face position so that the luminance of the face position can be appropriately controlled.

In the imaging device 1 according to the first embodiment, the face part detection unit 9 recognizes face part positions, the face part luminance calculation unit 10 calculates luminance of face parts, the exposure control value determination unit 12 performs exposure control using the luminance of the face part selected out of the face parts, and the distance measurement unit 17 determines distances to the face parts based on the first image and the second image.

Even if a face area includes a high-luminance portion that is not used to perform distance measurement (e.g., a high-luminance area R illustrated in FIG. 2), therefore, exposure control is performed based on the luminance of a face part area. Thus, the luminance of the face part can be appropriately controlled. On the other hand, in the conventional imaging device, an area is previously divided into areas, and the area including a face is detected. If a face area includes a high-luminance portion that is not used to perform distance measurement, exposure control is performed based on information relating to a luminance of an area including the high-luminance portion. Therefore, a luminance of a face position becomes excessively low (an S/N ratio becomes low). Therefore, parallax accuracy is low, and distance measurement accuracy is reduced. On the other hand, in the present embodiment, a luminance of a face part position does not become excessively high (saturation does not occur), and does not excessively low (because an S/N ratio is high). Therefore, parallax accuracy is high, and distance measurement accuracy is improved.

Furthermore, since an area where a luminance for exposure control is found and an area where a distance is found are the same face part area. Since each of the areas need not be individually detected, a calculation time required to detect the areas can be made shorter, and distance measurement can be performed at higher speed (in a shorter time). Since a common calculator is used to detect the areas, the cost of the device can be made lower by that amount (the amount corresponding to making the calculator common).

In the imaging device 1 according to the first embodiment, the face part detection unit 9 recognizes face part positions, the face part luminance calculation unit 10 calculates luminance of face parts, the face part luminance selection unit 11 selects the maximum one of the luminance of the face parts, the exposure control value determination unit 12 performs exposure control using the selected luminance, and the distance measurement unit 17 determines distances to the face parts based on the first image and the second image.

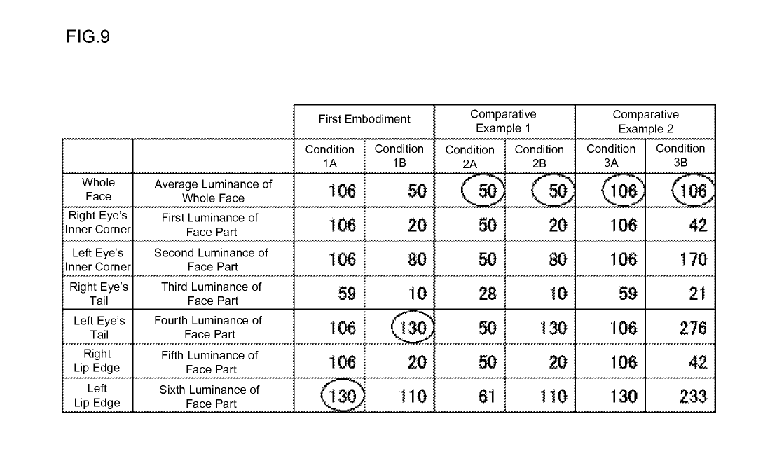

Thus, exposure control is performed using the maximum one of the luminance of the face parts. Even if a lighting condition is changed, therefore, the luminance of the face parts can always be appropriately controlled. This point will be described in detail below with reference to FIG. 9.

FIG. 9 is a table illustrating an example of an average luminance of the whole face and average luminance of face parts when the lighting condition is changed in the imaging device according to the first embodiment. As illustrated in FIG. 9, a condition 1A and a condition 1B indicate average luminance obtained when the imaging device 1 according to the present embodiment is used, and a condition 2A and a condition 2B indicate average luminance obtained when the conventional imaging device is used (a comparative example 1).

The conditions 1A and 2A respectively indicate average luminance obtained when a person is irradiated with a lighting from its substantially front side. At this time, a difference between a luminance of a face part on the right side of the person (e.g., a right inner corner a of the eye, a right tail c of the eye, a right lip edge e) and a face part on the left side thereof (e.g., a left inner corner b of the eye, a left tail d of the eye, a left lip edge f) is small. On the other hand, the conditions 1B and 2B respectively indicate average luminance obtained when the person is irradiated with a lighting from its left side. At this time, the luminance of the face part on the left side of the person is higher than the luminance of the face part on the right side thereof.

When the imaging device 1 according to the first embodiment is used, a target luminance is set to the maximum one of luminance of face parts a to f (a numerical value “130” enclosed by a circle in FIG. 9). More specifically, either one of the conditions 1A and 1B is controlled so that the maximum luminance of the face part is “130”. On the other hand, in the comparative example 1, a target luminance is set to the average luminance of the whole face (a numerical value “50” enclosed by a circle in FIG. 9). More specifically, either one of the conditions 2A and 2B is controlled so that the average luminance of the whole face is “50”. In this case, under the conditions 1B and 2B (lighting from the left), similar exposure control is performed. When the conditions 1A and 1B (lighting from the front) are compared with each other, however, the average luminance in the present embodiment is higher (the S/N ratio is higher) than that in the comparative example 1. Therefore, parallax accuracy is high, and distance measurement accuracy is improved.

In the comparative example 1, the target luminance can be merely increased. A condition 3A and a condition 3B respectively indicate average luminance obtained when a target luminance is merely increased (a target luminance is set to “106”) (a comparative example 2). In this comparative example 2, while a luminance can be appropriately increased under the condition 3A (lighting from the front), the luminance becomes excessively high (saturation occurs) under the condition 3B (lighting from the left). Therefore, parallax accuracy is low, and distance measurement accuracy is reduced. On the other hand, in the present embodiment, even if the lighting condition is changed (whether lighting is from the front or from the side), the luminance of the face parts can always be appropriately maintained.

Improvement can be undertaken by using a histogram or the like from that using the average luminance in the conventional imaging device. However, histogram calculation is complicated. Therefore, a calculation time can be made shorter when the average luminance is used as in the first embodiment than that when the histogram is used.

In the imaging device 1 according to the first embodiment, the first face detection unit 14 detects a first face area on the first image, to generate a first face position, the first face luminance calculation unit 15 calculates a first face luminance, and the second face detection unit 14 detects a face area on a second image, to generate a second face position, and the second face luminance calculation unit 15 calculates a second face luminance. An offset is added to a gain before correction to obtain a second gain while keeping a first gain the gain before correction so that the first face luminance and the second face luminance become the same.

Block matching can be accurately performed by making luminance in the same object of the first image captured by the first optical system 2 and the second image captured by the second optical system 2 the same. Therefore, parallax calculation and distance calculation can be accurately performed. Causes of a difference in luminance between the first image and the second image include a variation of the optical system 2, a variation of the image sensor 7, a variation of the circuit unit 8 (a gain device), and a variation of an analog-to-digital converter. The imaging device 1 according to the present embodiment can reduce the effects of the variations by making measurement to generate an offset when manufactured and obtaining a second gain having the offset added thereto.

The cause of the difference in luminance between the first image and the second image may be that the circuit unit 8 (gain device) has a temperature characteristic, and the first and second optical systems 2 differ in temperature and thus, differ in gain. The first and second images can differ in luminance due to causes such as a change with age of the optical systems 2, a change with age of the image sensor 7, a change with age of the gain device, and a change with age of the analog-to-digital converter. In such a case, in the imaging device 1 according to the first embodiment, block matching can be accurately performed by compensating for the difference in luminance between the first image and the second image. Therefore, parallax calculation and distance calculation can be accurately performed.

In the first embodiment, block matching is accurately performed by correcting the second gain in the exposure control amount (the diaphragm value, the exposure time, and the gain) and compensating for the difference in luminance between the first image and the second image, to accurately perform parallax calculation and distance calculation. Even if the diaphragm value and the exposure time are changed in place of the gain, the difference in luminance between the first image and the second image can be similarly compensated for. Therefore, block matching can be accurately performed, to accurately perform parallax calculation and distance calculation. When the first camera unit and the second camera unit differ in diaphragm values, the first camera unit and the second camera unit differ in depths of focus, and the first image and the second image differ in degrees of blur. This causes deterioration in accuracy in the block matching. When the first camera unit and the second camera unit differ in exposure time, and the first camera unit and the second camera unit differ in exposure lengths when the object moves at high speed, and the first image and the second image differ in degrees of object shake. This causes deterioration in accuracy in the block matching. Therefore, the difference in luminance between the first image and the second image may desirably be compensated for by correcting the gain in the exposure control amount (the diaphragm value, the exposure time, and the gain).

While an example in which the face part luminance selection unit 11 selects the maximum one of luminance of face parts, and the exposure control value determination unit 12 performs exposure control based on the selected luminance has been described in the present embodiment, the scope of the present invention is not limited to this. For example, the face part luminance selection unit 11 may remove, out of pairs of right and left face parts, the pair of right and left face parts between which there is a great difference in luminance select the maximum one of luminance of the remaining face parts, and the exposure control value determination unit 12 may perform exposure control based on the selected luminance of the face part.

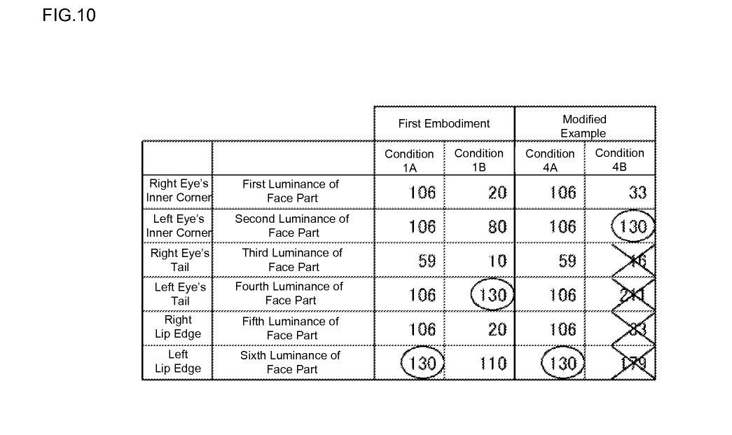

FIG. 10 illustrates a modified example in which luminance of face parts are selected. A condition 4A and a condition 4B indicate average luminance in the modified example, where the condition 4A indicates the average luminance obtained when a person is irradiated with a lighting from its substantially front side, and the condition 4B indicates the average luminance obtained when a person is irradiated with a lighting from its left side. Under the condition 4A, pairs of right and left face parts do not include a pair of right and left face parts between which there is a great difference in luminance. Therefore, the condition 4A is controlled so that the maximum one of the luminance of the face parts is 130 (a numerical value enclosed by a circle), like that in the first embodiment (similarly to the condition 1A). On the other hand, under the condition 4B, pairs of right and left face parts include pairs of right and left face parts between which there is a great difference in luminance. Therefore, the pairs are removed. In this example, the condition 4B is controlled so that a set of luminance of the third face part c and the fourth face part d (numerical values crossed out) and a set of luminance of the fifth face part e and the sixth face part f (numerical values crossed out) are removed, the maximum one of luminance of the remaining face part a and second face part b is selected, and the luminance of the face part is 130 (the luminance of the second face part b, enclosed by a circle). When distance measurement is performed using the luminance of the remaining face parts, excluding the pairs of right and left face parts between which there is a great difference in luminance, an exposure time is lengthened, and the luminance is increased. Thus, the luminance of the pair of right and left face parts (between which there is a small difference in luminance) having high reliability can be appropriately increased, and accuracy of measurement of distances to the face parts can be improved.

In the imaging device 1 according to the first embodiment, in the exposure control value determination unit 12, the target value setting unit 18 sets a target value depending on a luminance of a face part selected from the first image, and the exposure control calculation unit 19 determines an exposure control value (an exposure control value before correction) so that the luminance of the face part matches the target value. The target value setting unit 18 sets the target value to a predetermined first target value when the selected luminance is less than a predetermined threshold value, and sets the target value to a predetermined second target value (smaller than the first target value) when the selected luminance is the predetermined threshold value or more. Thus, the luminance can be appropriately adjusted quickly by decreasing the target value when high. Therefore, a period during which parallax calculation accuracy is low and a period during which distance measurement accuracy is low can be shortened. This enables parallax calculation and distance calculation to be performed with high accuracy only for a longer period.

In the imaging device 1 according to the first embodiment, the saturation signal generation unit 13 generates a saturation signal indicating whether a saturated portion exists at a face part position based on the first image, and the exposure control value determination unit 12 determines an exposure control value (an exposure control value before correction) based on the luminance of the selected face part and the saturation signal. The exposure control value determination unit 12 performs exposure control calculation every time only four images are accepted when the saturation signal is “L” (when saturation does not occur), while immediately performing exposure processing calculation by initializing the counter N to zero when the saturation signal is “H” (when saturation occurs). Thus, the luminance can be appropriately adjusted quickly by immediately performing exposure control calculation when saturation occurs. Therefore, a period during which a luminance is high and distance measurement accuracy is low and a period during which distance measurement accuracy is low can be shortened. This enables parallax calculation and distance calculation to be performed with high accuracy only for a longer period.

While the first optical system 2 performs image capturing based on the first diaphragm value, the first exposure time, and the first gain, and the second optical system 2 performs image capturing based on the second diaphragm value, the second exposure time, and the second gain in the imaging device 1 according to the first embodiment, some of the exposure control values may be fixed. Alternatively, the optical system 2 need not have a mechanism for changing a diaphragm value.

While the second face position is generated from the second image in the imaging device 1 according to the first embodiment, a position shifted by an amount corresponding to a parallax from the first face position may be the second face position. The parallax may be sequentially calculated. Alternatively, the parallax may be the predetermined value by considering a distance to an object to be substantially constant.

### Second Embodiment

In a second embodiment of the present invention, a driver monitoring device used for a system for detecting inattentive driving and drowsy driving, for example, is illustrated by an example.

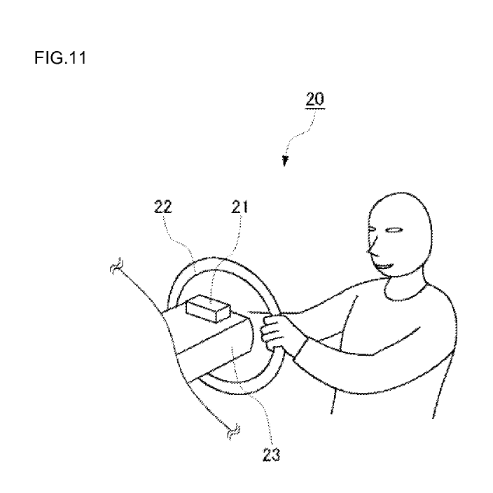

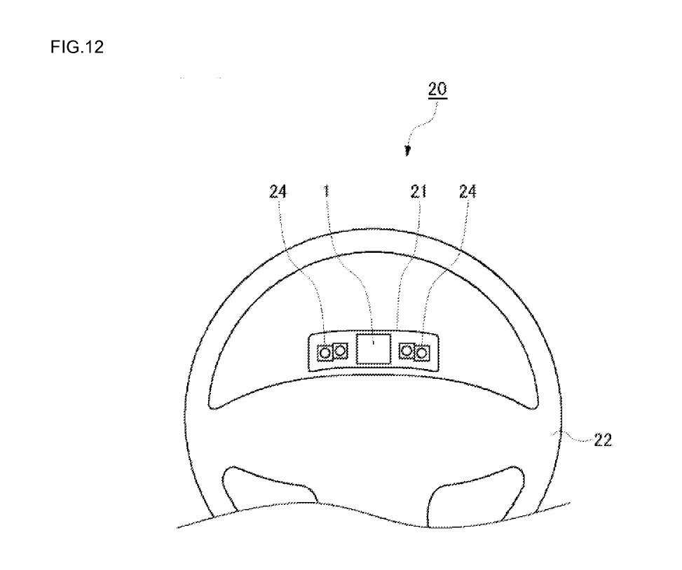

A configuration of the driver monitoring device according to the present embodiment will be first described with reference to FIGS. 11 to 13. FIG. 11 is a schematic view of a driver monitoring device, and FIG. 12 is a front view of the driver monitoring device. As illustrated in FIGS. 11 and 12, a camera unit 21 in the driver monitoring device 20 is mounted on a steering column 23 for supporting a steering wheel 22, and the camera unit 21 is arranged so that an image of a driver can be captured from the front. In this case, the camera unit 21 includes the imaging device 1 according to the first embodiment, and a plurality of supplemental lightings 24 (e.g., a near-infrared light emitting diode (LED)) for irradiating the driver. An output from the imaging device 1 is input to an electronic control unit 25.

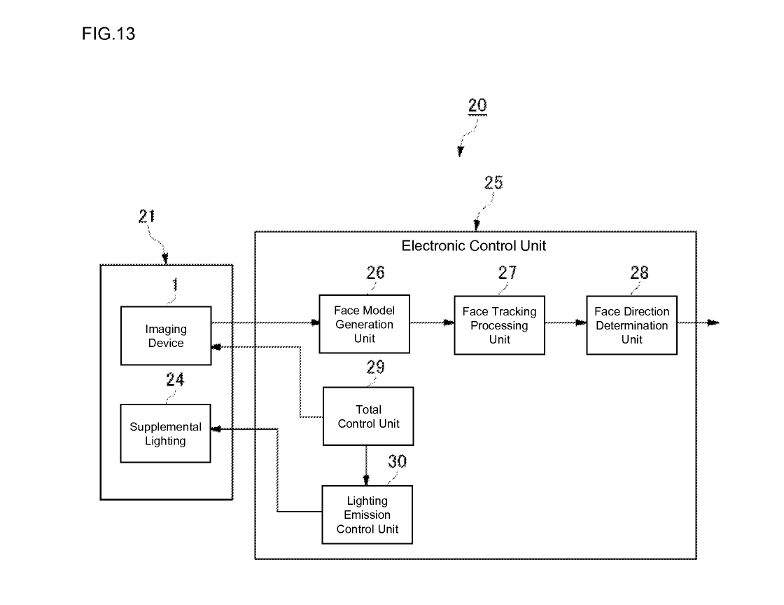

FIG. 13 is a block diagram for illustrating a configuration of the driver monitoring device 20. The driver monitoring device 20 includes the camera unit 21 and the electronic control unit 25. The camera unit 21 includes the imaging device 1 and the supplemental lightings 24. The electronic control unit 25 includes a face model generation unit 26 for calculating three-dimensional positions of a plurality of face part characteristic points based on an image and a distance input from the imaging device 1, a face tracking processing unit 27 for sequentially estimating a direction of the face of the driver from images sequentially captured, and a face direction determination unit 28 for determining the direction of the face of the driver from processing results of the face model generation unit 26 and the face tracking processing unit 27. The electronic control unit 25 includes a total control unit 29 for controlling an overall operation of the imaging device 1, including an image capturing condition or the like, and a lighting emission control unit 30 for controlling light emission of the supplemental lighting 24 based on a control result of the total control unit 29.

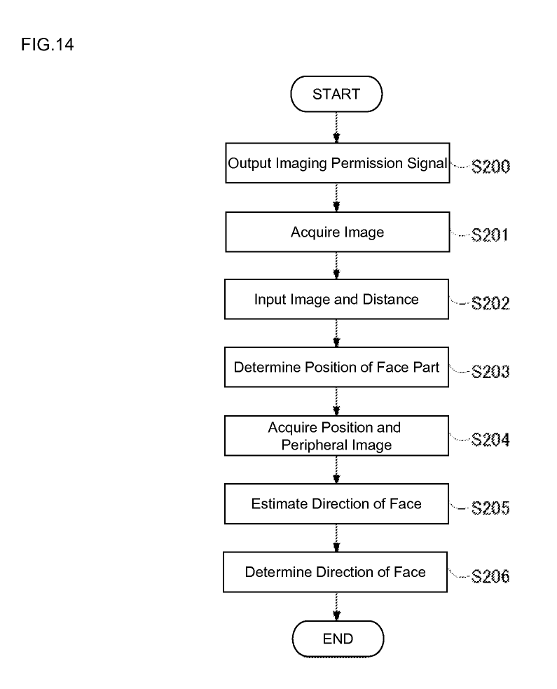

Operations of the driver monitoring device 20 configured as described above will be described with reference to FIG. 14.

In the driver monitoring device 20 according to the present embodiment, an imaging permission signal is output from the total control unit 29 in the electronic control unit 25 to the imaging device 1 (S200). The imaging device 1 looks up at a driver from the front at an angle of approximately 25 degrees, to acquire a front image in response to the signal (S201). The lighting light emission control unit 30 controls the supplemental lighting 24 in synchronization with the signal, to irradiate the driver with near infrared light for a predetermined time. An image obtained by capturing the driver and a distance to the image are acquired by the imaging device 1 for a period corresponding to 30 frames, for examples, and are input to a face model generation calculation circuit (S202). The face model generation calculation circuit determines three-dimensional positions of a plurality of face parts from the acquired distance by calculation (S203). Information relating to the three-dimensional positions of the plurality of face parts obtained by the calculation and a peripheral image of the face parts the three-dimensional positions of which have been acquired are simultaneously acquired (S204).

The face tracking processing unit 27 sequentially estimates the direction of the face of the driver using a particle filter (S205). For example, it is predicted that the face has moved in a direction from a position of the face in a frame preceding the current frame. A position to which the face part has moved by the predicted movement is estimated based on the information relating to the three-dimensional positions of the face parts, which have been acquired by the face model generation unit 26, and the current acquired image at the estimated position and a peripheral image of the face parts, which have already been acquired by the face model generation unit 26, are correlated by template matching. A plurality of patterns of the current direction of the face is predicted based on probability density and motion history of the direction of the face in the frame preceding the current frame, to obtain a correlation value by template matching in a similar manner to the above for each of the predicted patterns.

The face direction determination unit 28 determines the current direction of the face from the estimated direction of the face and the correlation value by pattern matching in the direction of the face, and outputs the current direction of the face outward (S206). This makes it possible to determine inattentive driving or the like of the driver, raise an alarm or the like to the driver, and draw attention based on vehicle information and peripheral vehicle information, for example.

The face direction determination unit 28 reacquires, when it determines that the direction of the face cannot be correctly determined from the correlation value by pattern matching for the reason that the original image for template matching, which has already been acquired, and the current image differ from each other, for example, when the driver greatly shakes his/her face, information relating to a three-dimensional position of a face part at that time point and its peripheral image serving as an original image for template matching, and performs similar processing to the above, to determine the direction of the face of the driver.

In the driver monitoring device 20 according to the second embodiment, the direction of the face is detected using the imaging device 1 capable of determining an appropriate luminance, determining an accurate parallax, and thus determining an accurate distance. The direction of the face can be accurately detected because it is detected using this accurate distance.

When the direction of the face is detected in the driver monitoring device 20, distance information relating to a face part such as an eye is required, while distance information relating to a forehead or the like is not required. At this time, in a conventional device, even when a high-luminance object such as a light other than a face is not included, if there is a high-luminance portion such as a reflection in a part of the face, e.g., the forehead, an exposure time is shortened by an amount corresponding to the high-luminance portion. Therefore, in the face part such as the eye, a luminance is low (an S/N ratio is low), parallax accuracy is reduced, and distance measurement accuracy is reduced. Therefore, the accuracy of detection of the direction of the face performed by the driver monitoring device 20 using a distance measurement result becomes low.

On the other hand, in the driver monitoring device 20 according to the second embodiment, an accurate image and an accurate distance are acquired from the imaging device 1 according to the first embodiment. The face model generation unit 26 generates a face model based on the distance, and the face tracking processing unit 27 sequentially estimates the direction of the face from the face model and images obtained by sequentially capturing the face of the driver at predetermined time intervals. Thus, the direction of the face of the driver can be detected with high accuracy because it is detected using the image and distance calculated with high accuracy by appropriately controlling the luminance of the face and calculating a parallax with high accuracy.

While in the driver monitoring device 20 according to the second embodiment, an example in which the supplemental lighting 24 for irradiating the driver is arranged in the vicinity of the imaging device 1 has been described, a position where the supplemental lighting 24 is arranged is not limited to that in this example. The supplemental lighting 24 may be installed at any position as long as it can irradiate the driver.

While in the driver monitoring device 20 according to the second embodiment, an example in which face direction determination result is used for determining inattentive driving has been described, the scope of the present invention is not limited to this. For example, the direction of a line of sight can also be detected by detecting a three-dimensional position of a black eye from an acquired image. Alternatively, a face direction determination result and a line-of-sight direction determination direction can also be used for various operation support systems.

While in the driver monitoring device 20 according to the second embodiment, the imaging device 1 detects a face part and measure a distance, and the electronic control unit 25 detects the direction of a face, the sharing of the functions is not limited to this. For example, the electronic control unit 25 may detect a face part and measure a distance. Alternatively, the electronic control unit 25 may have some of the functions of the imaging device 1.

While the embodiments of the present invention have been illustrated by examples, the scope of the present invention is not limited to these. The present invention can be changed or modified according to an object within the scope described in the claims.

While the preferred embodiments of the present invention considered at this time point have been described above, it is understood that various modifications can be made for the present embodiments, and the scope of the appended claims is intended to include all such modifications within the spirit and scope of the present invention.

### INDUSTRIAL APPLICABILITY

As described above, an imaging device according to the present invention has the effect of measuring distances to face parts with high accuracy, and is usefully used for a driver monitoring device for detecting a direction of the face of a driver.

### REFERENCE SIGNS LIST

1 imaging device
2 optical system
3 camera unit
4 control unit
9 face part detection unit
10 face part luminance calculation unit
11 face part luminance selection unit
12 exposure control value determination unit
13 saturation signal generation unit
14 face detection unit
15 face luminance calculation unit
16 exposure control value correction unit
17 distance measurement unit
18 target value setting unit
19 exposure control calculation unit
20 driver monitoring device
21 camera unit
25 electronic control unit
26 face model generation unit
27 face tracking processing unit
28 face direction determination unit

1. An imaging device, comprising:
a camera unit that respectively captures, by using at least two optical systems, images of the same object;
a face part detection unit that detects, from each of the images captured by the camera unit, a plurality of face parts composing a face included in the image;
a face part luminance calculation unit that calculates luminance of the detected plurality of face parts;
an exposure control value determination unit that determines an exposure control value of the camera unit based on the luminance of the plurality of face parts; and
a distance measurement unit that measures distances to the plurality of face parts based on the at least two images captured by the camera unit using the corrected exposure control value, wherein
the exposure control value determination unit determines the exposure control value of the camera unit so that the maximum one of the luminance of the plurality of face parts becomes a predetermined target luminance.

2. (canceled)

3. The imaging device according to claim 1, wherein the exposure control value determination unit determines, when a difference between the luminance of a pair of face parts symmetrically arranged out of the plurality of face parts is greater than a predetermined threshold value, the exposure control value of the camera unit so that the maximum one of the luminance of the face parts excluding the pair of face parts becomes a target luminance.

4. The imaging device according to any one of claims 1 to 3, further comprising
a face detection unit that detects the faces respectively included in the images captured by the camera unit,
a face luminance calculation unit that calculates luminance of the detected faces, and
an exposure control value correction unit that corrects the exposure control value of the camera unit based on the luminance of the faces,
wherein the exposure control value correction unit corrects the exposure control value of the camera unit so that the luminance of the face parts included in the at least two images captured by the camera unit become the same.

5. The imaging device according to claim 4, wherein
the exposure control value includes a diaphragm value, an exposure time, and a gain,
the exposure control value correction unit makes the respective diaphragm values and exposure times of the two optical systems the same, and corrects the respective gains of the two optical systems so that the luminance of the face parts included in the two images become the same.

6. The imaging device according to any one of claims 1 to 5, wherein the exposure control value determination unit sets a target luminance depending on the selected one of the luminance of the plurality of face parts, and determines the exposure control value of the camera unit so that the selected luminance becomes the target luminance.

7. The imaging device according to claim 6, wherein the exposure control value determination unit sets the target luminance to a smaller value when the selected luminance is larger than a predetermined threshold value than that when the selected luminance is smaller than the threshold value.

8. The imaging device according to any one of claims 1 to 7, wherein the exposure control value determination unit controls a frequency at which the exposure control value of the camera unit is found based on the presence or absence of a saturation signal indicating that the luminance of the face part is higher than a predetermined reference saturation value.

9. The imaging device according to claim 8, wherein the exposure control value determination unit determines the exposure control value of the camera unit every time the image is captured when the saturation signal is present.

10. A driver monitoring device, comprising:
a camera unit that respectively captures, by using at least two optical systems, images of a driver as an object of shooting;
a face part detection unit that detects a plurality of face parts composing a face of the driver from each of the images captured by the camera unit;
a face part luminance calculation unit that calculates luminance of the detected plurality of face parts;
an exposure control value determination unit that determines an exposure control value of the camera unit based on the luminance of the plurality of face parts;
a distance measurement unit that measures distances to the plurality of face parts of the driver based on the at least two images captured by the camera unit using the exposure control value;
a face model generation unit that generates a face model of the driver based on distance measurement results of the plurality of face parts; and
a face tracking processing unit that performs processing for tracking a direction of the face of the driver based on the generated face model, wherein
the exposure control value determination unit determines the exposure control value of the camera unit so that the maximum one of the luminance of the plurality of face parts becomes a predetermined target luminance.

11. A method for measuring a distance to a face, comprising:
capturing respectively, by using at least two optical systems, images of the same object;
detecting a plurality of face parts composing the face included in each of the captured images;
calculating luminance of the detected plurality of face parts;
determining an exposure control value for image capturing based on the luminance of the plurality of face parts so that the maximum one of the luminance of the plurality of face parts becomes a predetermined target luminance; and
measuring distances to the faces based on the at least two images captured using the exposure control value.

12. A program for measuring a distance to a face, causing a computer to execute:
processing for detecting a plurality of face parts composing the face included in each of images of the same object, the images being respectively captured by at least two optical systems;
processing for calculating luminance of the detected plurality of face parts;
processing for determining an exposure control value for image capturing based on the luminance of the plurality of face parts so that the maximum one of the luminance of the plurality of face parts becomes a predetermined target luminance; and
processing for measuring distances to the faces based on the at least two images captured using the exposure control value.
